(19) United States
(12) Patent Application Publication
(10) Pub. No.: US 2026/0322209 A1
(43) Pub. Date: Oct. 15, 2026

(54) STATOR MOTOR FOR A FLYWHEEL

(71) Applicant: WATTSUP POWER A/S, Hvidovre (DK)

(72) Inventors: Martin SPEIERMANN, Bronshøj (DK); Henrik VIKELGAARD, Lejre (DK); Alessandro D´AMBROSIO, Hvidovre (DK); Alex LINDROS, Hvidovre (DK)

(21) Appl. No.: 19/491,531

(22) PCT Filed: Jun. 7, 2024
(86) PCT No.: PCT/IB2024/055609

§ 371 Date: Dec. 9, 2025

Related U.S. Application Data
(60) Provisional application No. 63/472,062, filed on Jun. 9, 2023.

(51) Int. Cl. H02K 7/02; H02K 1/02; H02K 1/16; H02K 3/02; H02K 3/48; H02K 5/20

(52) U.S. Cl. CPC H02K 7/025; H02K 1/02; H02K 1/16; H02K 3/02; H02K 3/48; H02K 5/203

(57) ABSTRACT

A stator motor of a flywheel configured to be disposed within a rotor has a stator tube with a cooling jacket on its interior, the cooling jacket having multiple cooling ducts; a stator yoke extending radially outward from the stator tube to a radially outward side of the stator motor; and at least one inductive winding. The motor has potting ends that caps its axial ends the winding disposed within the potting ends. The winding is copper and magnetically coupled to permanent magnets of the rotor. In embodiments, the stator tube is thermally coupled to a first cooling plate, the at least one cooling plate disposed between the first potting end and the stator yoke and is formed of sapphire or aluminum nitride ceramic. In embodiments, a second cooling plate is disposed between subyokes of the stator yoke.

### PRIORITY

This document claims priority to U.S. Provisional Patent Application 63/472,062 filed Jun. 9, 2023. The entire contents of the aforementioned provisional patent application are incorporated herein by reference.

### BACKGROUND

A flywheel is a mechanical device that stores rotational energy in a rotating mass, i.e., a rotor. The amount of energy stored in the rotor is proportional to the square of the rotor's rotational speed. The rotor may be magnetically coupled with an electromagnetic generator stator to allow the flywheel to convert between rotational energy of the rotor and electrical energy. The generator stator may decelerate the rotor to produce electrical energy from the rotational energy extracted from the rotor. The generator stator may also, in a reverse process, receive electrical energy and convert this electrical energy to rotational energy of the rotor resulting in acceleration of the rotor. Flywheel systems may be designed to have large energy storage capacity and are further capable of both delivering and absorbing energy rapidly. Common uses of a flywheel include peak-shaving of the power output of another energy source (such as a combustion generator stator), energy storage, backup power supply, and rapid energy delivery.

### SUMMARY

Low-loss energy storage in a flywheel requires that the rotor rotates with very little friction. Therefore, the rotor of a high-performance flywheel typically is magnetically levitated to counteract the gravitational force and to maintain stability during operation. It is also typically housed in a vacuum chamber to reduce air drag. However, energy loss still may exist, and much of the loss may come from the stator motor. The present embodiments include a stator motor that uses axial segmentation to reduce the energy loss of the flywheel.

A stator motor of a flywheel configured to be disposed within a rotor has a stator tube with a cooling jacket on its interior, the cooling jacket having multiple cooling ducts; a stator yoke extending radially outward from the stator tube to a radially outward side of the stator motor; and at least one inductive winding. The motor has potting ends that cap its axial ends, and windings are disposed within the potting ends. The winding is copper and magnetically coupled to permanent magnets of the rotor. In embodiments, the stator tube is thermally coupled to at least one cooling plate, the at least one cooling plate disposed between the first potting end and the stator yoke. The cooling plates may be formed of sapphire or aluminum nitride ceramic. In embodiments, a second cooling plate is disposed between subyokes of the stator yoke.

Various components of the flywheel may produce heat that must be removed to prevent damage from overheating, this is done by conducting the heat through the cooling plates to the stator tube and transferring heat through the stator tube to the cooling jacket.

### BRIEF DESCRIPTION OF THE FIGURES

FIG. 1 is a cross-sectional view of a flywheel, according to an embodiment.

FIG. 2 is a more detailed view of a portion of FIG. 1.

FIG. 3A is a perspective view of a stator motor for use with the flywheel of FIG. 1.

FIG. 3B is a side view of the stator motor of FIG. 3A.

FIG. 4A is a perspective view of another stator motor for use with the flywheel of FIG. 1.

FIG. 4B is a side view of the stator motor of FIG. 4A.

FIG. 5 is a temperature plot of the outer radius of the stator motor of FIGS. 3A-3B.

FIGS. 6A and 6B show a temperature comparison at the outer radius of the stator motor without cooling plates when using aluminum and using stainless steel for the stator tube.

FIGS. 7A, 7B, and 7C show a temperature comparison for the stator motors when using aluminum for the stator tube.

FIGS. 8A, 8B, and 8C show a temperature comparison for the stator motors when using stainless steel for the stator tube.

FIG. 9 is a temperature plot of the outer radius of a stator motor showing the effect of having cooling plates when using aluminum for the stator tube.

FIG. 10 is a schematic diagram of a flywheel system incorporating a stator motor of the present design.

FIG. 11 is a flowchart of a method of cooling the stator motor herein described.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with the disclosure. Instead, they are merely examples of apparatuses and methods consistent with aspects related to the disclosure as recited in the appended claims.

Flywheel systems may be used in environments where access to a conventional electrical grid is not available. Instead, such environments rely on a so-called “micro grid.” In these environments, flywheel systems may provide power functionalities such as energy storage, backup power, peak-shaving, and frequency control. Flywheel systems may serve to rapidly meet a high, short-term power demand.

A flywheel often employs a magnetic levitation bearing that levitates a rotor of the flywheel above a base of the flywheel. The rotor typically rotates about a vertical rotation axis. Conventionally, the magnetic levitation bearing is configured to counteract gravity and, for this purpose, applies an axial force to the rotor. Herein “axial” refers to any direction parallel to the rotation axis of the flywheel, and “radial” refers to any direction that is perpendicular to the rotation axis.

The magnetically levitated rotor of a high-performance flywheel typically counteracts the gravitational force and results in low energy loss for a flywheel with very little friction. However, energy loss still may exist, and the loss may result in increased temperature of internal components of the flywheel, typically in the stator motor. The present embodiments include a stator motor that uses axial segmentation and materials with high thermal conductivity to reduce the energy loss of the flywheel.

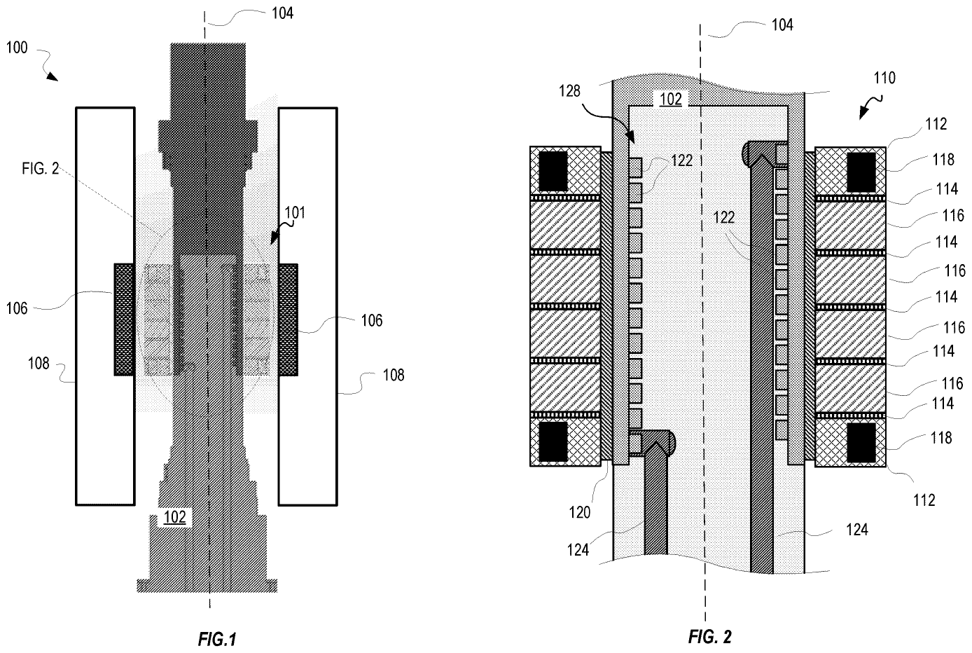

FIG. 1 is a cross-sectional view along the rotational axis 104 of a generator section 101 of a flywheel 100. FIG. 2 is a more detailed view of a portion of FIG. 1. FIGS. 1 and 2 are best viewed together in the following discussion. Flywheel 100 includes a stationary shaft 102 and a rotor 108 that rotates about the stationary shaft 102. In embodiments, flywheel 100 may be enclosed in a vacuum chamber (not shown) and is supported by magnetic bearings (not shown). Stator motor 110 is thus configured to be disposed within a cavity of, and along rotational axis 104 of rotor 108 of the flywheel 100. While FIG. 1 shows the flywheel 100 with only one generator section 101, the flywheel 100 may alternatively have more than one generator section 101. In embodiments, a plurality of generator sections 101 may be used with a single rotor 108, or each generator section may be paired with a separate rotor 108. Each generator section 101 typically has the same rotational axis 104.

The rotor 108 has a plurality of attached permanent magnets 106. The generator section 101, which includes a stator motor 110, is mechanically coupled to the stationary shaft 102. In operation, the generator section 101 performs one or both of two functions: (i) magnetically converting rotational energy of the rotor 108 to an electrical energy output of the flywheel 100 and, conversely, (ii) magnetically converting electrical energy inputted to the flywheel 100 to rotational energy of the rotor 108.

FIG. 2 is a cross-sectional view of the stator motor 110 with axial cooling plates 114. The stator motor 110 includes potting ends 112 and a plurality of stator subyokes 116, separated by axial cooling plates 114. Although four stator subyokes are illustrated, any number may be used, depending on the application. Stator motor 110 also includes a stator tube 120 and a winding 118 in each potting end 112. In embodiments, each stator subyoke 116 is made from a non-magnetic material such as stainless steel or aluminum. At least one winding 118, and in embodiments multiple windings, are enclosed inside the potting ends 112. In an embodiment, the windings 118 are wound of copper wire. The stator motor 110 is magnetically coupled with the plurality of permanent magnets 106 (FIG. 1) attached to the rotor 108 to convert between rotational energy of the rotor 108 and electric current in the windings 118 of the stator motor 110.

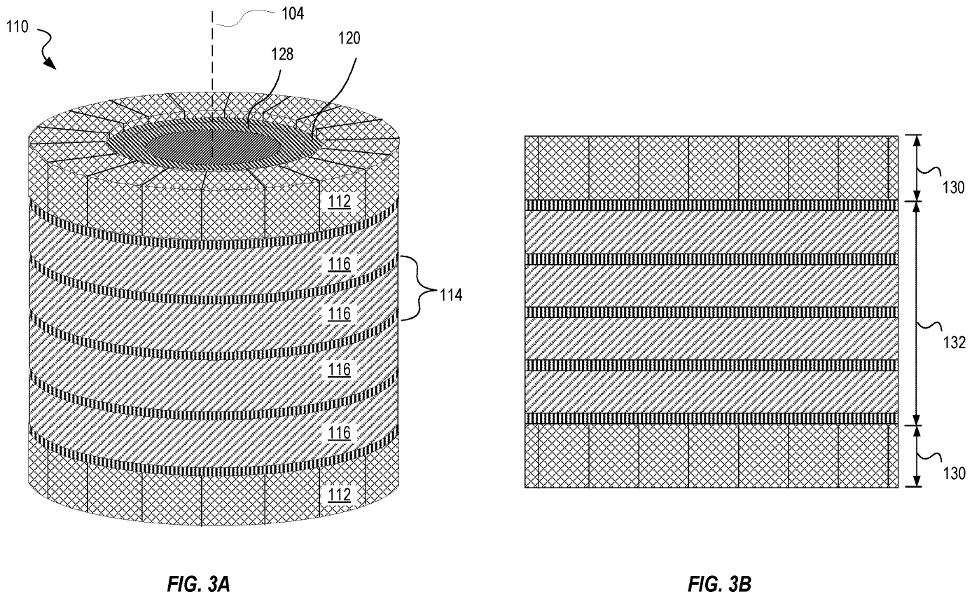

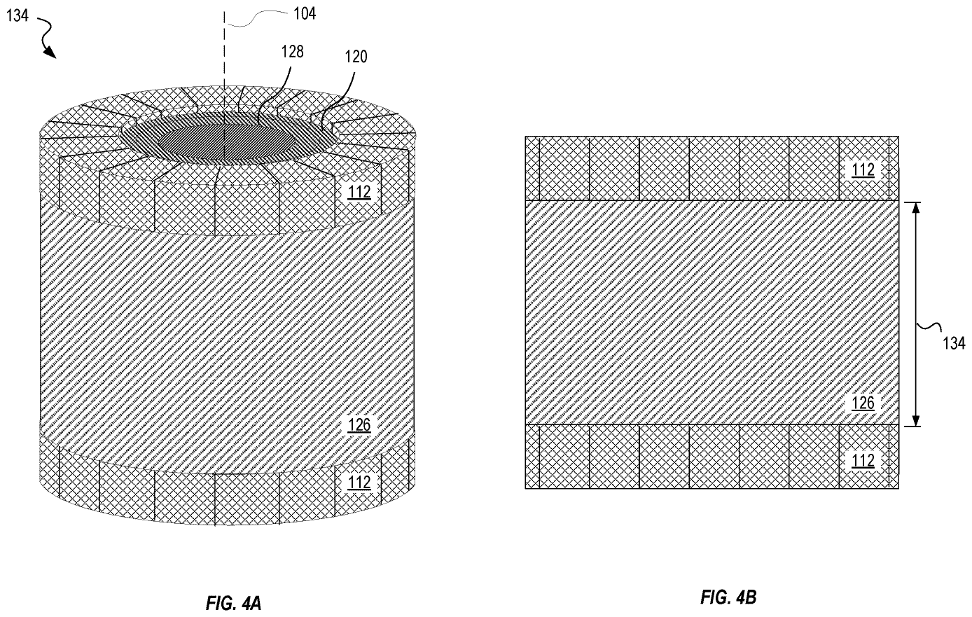

FIG. 3A is a perspective view of a stator motor for use with the flywheel of FIG. 1. FIG. 3B is a side view of the stator motor of FIG. 3A. Cooling jacket 128 is disposed on a radially inward side of stator tube 120. A plurality of stator subyokes 116 are separated from each other and from potting ends 112 by axial cooling plates 114. In embodiments, axial cooling plates 114 are formed from a high thermal conductivity material such as sapphire or aluminum nitride (AlN) ceramic. Axial cooling plates 114 help remove waste heat from the stator motor since common heat removal strategies, like fan-blown air or convective cooling, fail when the stator motor is enclosed in a vacuum housing. Axial cooling plates 114 are thermally coupled to a stator tube 120.

In embodiments, potting ends may have an axial length 130 of approximately 40 mm. Each stator subyoke 116 may have a length of approximately 45 mm for a total motor length of 180 mm. The total length of the plurality of stator subyokes 116 and axial cooling plates 114 may be approximately 205 mm and the overall length including the potting ends may be approximately 285 mm. Other dimensions are contemplated depending on the application.

FIG. 4A is a perspective view of another stator motor 134 for use with the flywheel of FIG. 1. FIG. 4B is a side view of the stator motor of FIG. 4A. Stator motor 134 includes a unitary stator yoke 126 with upper and lower potting ends 112 at opposing axial ends of unitary stator yoke 126 and does not include any axial cooling plates. In embodiments, a unitary stator yoke has a length of approximately 180 mm. Stator motor may have an overall length of approximately 260 mm.

The stator motors 110 and 134 also includes a cooling jacket 128. The cooling jacket 128 includes a plurality of cooling ducts 122 (FIG. 2). In an embodiment, the cooling jacket 128 is disposed on the radially inward side of the stator tube 120 and covers the entire axial length of the stator tube 120. The cooling jacket 128 provides active cooling to the stator motors 110 and 134. However, thermal conductivity of the stator yoke 116 may determine the temperature of the outer radius of the stator motor 110, where the temperature is expected to be the highest.

### Experimental Demonstration

In embodiments, the rotor may operate at variable speeds ranging from near zero to over 100,000 RPM. These experiments were performed at 37,500 RPM to permit comparison between measurements.

As presented below, the thermal impact of the design and material choice of each of the stator motors 110 and 134 was experimentally explored. For the cooling plates, three cases were considered: (i) the stator motor 134 without cooling plates, (ii) the stator motor 110 with sapphire cooling plates, and (iii) the stator motor 110 with AlN ceramic cooling plates. For the stator tube, stainless steel and aluminum were considered. All measurements hereinbelow were taken or simulated with the cooling jacket fluid set to 18° C. and the rotor operating at 37,500 revolutions for minute (RPM) unless specified otherwise.

Table 1 show example energy loss for various input conditions used in thermal modeling.

TABLE 1

| | Losses w/o Cooling Plates | | | Losses with Cooling Plates | | |
|---|---|---|---|---|---|---|
| OUTPUT | 9000 | 25000 | 37500 | 9000 | 25000 | 37500 |
| DATA/RESULTS/LOAD | rpm | rpm | rpm | rpm | rpm | rpm |
| Voltage LL RMS (V) | 169.7 | 466.9 | 675.4 | 158.1 | 433.3 | 624.5 |
| Average torque (Nm) | 51.7 | 51.5 | 49.6 | 48.9 | 48.7 | 46.8 |
| Cogg Torque pk-pk (Nm) | 12.8 | 10.3 | 6.24 | 19.4 | 15.8 | 10.2 |
| Average power (kW) | 48.7 | 134.8 | 194.5 | 46.1 | 127.6 | 183.8 |
| Phase current RMS (A) | 180 | 180 | 180 | 180 | 180 | 180 |
| PM Loss (W) | 3 | 262.2 | 192.2 | 34.5 | 377.1 | 216.3 |
| Rotor Yoke Loss (W) | 0.1 | 2.3 | 2.5 | 0.4 | 4 | 3.9 |
| Stator Yoke Loss (W) | 945.4 | 3742 | 6321.8 | 886.6 | 3142.3 | 5232.7 |
| Cooling jacket loss (W) | 2.2 | 10.8 | 10.8 | 24.1 | 35.2 | 22.5 |
| Glass fiber | NA | NA | NA | NA | NA | NA |
| ring loss (W) | | | | | | |
| Carbon fiber | NA | NA | NA | NA | NA | NA |
| ring loss (W) | | | | | | |
| Casing loss (W) | NA | NA | NA | NA | NA | NA |
| Max B at 1 mm | 58.8 | 55.2 | 48.7 | 43.4 | 44.1 | 42.1 |
| outside rotor | | | | | | |
| yoke (mT) | | | | | | |
| Avg B at 1 mm | 20 | 17.4 | 11.1 | 16.7 | 14.6 | 9.4 |
| outside rotor | | | | | | |
| yoke (mT) | | | | | | |
| Magnet min H | −468.9 | −476.8 | −493.9 | −478.9 | −485.6 | −501.8 |
| field (kA/m) | | | | | | |
| Safety factor to | 35.8% | 34.7% | 32.3% | 34.4% | 33.5% | 31.3% |
| magnet Hknee (%) | | | | | | |

Table 1 shows that energy loss in the stator yoke is the highest among the components of the flywheel. However, energy loss in the stator yoke of a stator motor with axial cooling plates, such as the stator motor 110, is significantly less than the energy loss in the stator yoke of a stator motor without axial cooling plates, such as the stator motor 134, for all listed speeds. In the example of Table 1, energy loss by the stator yoke at an operating speed of 37,500 RPM is 6321.8 W for a stator motor without any axial cooling plates while the energy loss is 5232.7 W for a stator motor that includes axial cooling plates. In this example, the cooling plates facilitate the thermal transfer from the cooling jacket.

Therefore, it may be advantageous to choose a design and a material type that increases thermal conductivity for the stator parts including the cooling plates (e.g., axial cooling plates 114) and the stator tube (e.g., stator tube 120). Examples of material that may be used for the cooling plates include, but are not limited to, sapphire and ceramic aluminum nitride (AlN), where the thermal conductivities for sapphire and AlN are 41 W/(m·K) and 180 W/(m·K), respectively. Examples of material that may be used for the stator tube include, but are not limited to, aluminum and stainless steel, where the thermal conductivities for aluminum and stainless steel are 202 W/(m·K) and 16.2 W/(m·K), respectively.

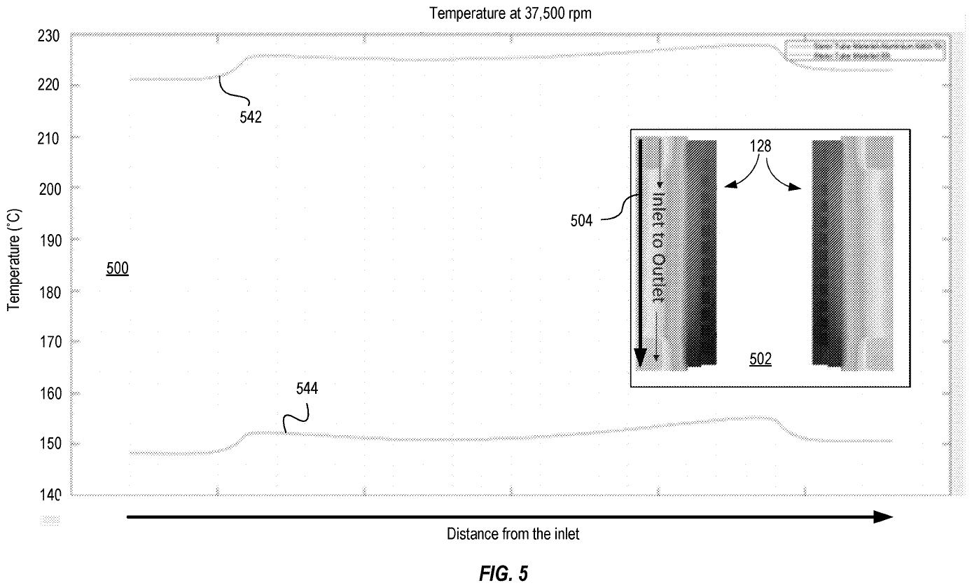

FIG. 5 is a temperature plot 500 of the outer radius of a stator motor. FIG. 5 includes an inset that shows a temperature map 502 of a cross-section of the stator motor 134 without cooling plates while the flywheel is operating at 37,500 RPM. The temperature map 502 shows cooler temperatures at the inner radius of the stator motor 134 where the cooling jacket (e.g., cooling jacket 128 of FIG. 2) is located. It also shows the gradual increase in temperature going from the inner to the outer radius of the stator motor 134. The highest temperatures may be observed at or near the outer radius of the stator motor 134. Temperature traces 542 and 544 show the temperatures at the outer radius in a direction 504 indicated in the temperature map 502.

The material used for the stator tube (e.g., stator tube 120) also determines the temperature distribution and gradient within the stator motor 134. For example, when stainless steel is used for the stator tube, the temperature at the outer radius of the stator motor has a range between 220° C. and 230° C., as shown in the temperature trace 542. In contrast, when aluminum (e.g., 6063-T6) is used for the stator tube, temperature range at the outer radius of the stator motor is between 145° C. and 155° C., as shown in the temperature trace 544. Higher temperatures in any part of the flywheel may correspond to energy loss and may contribute to inefficiency. Therefore, it may be beneficial to identify components of the flywheel that exhibit the highest energy loss.

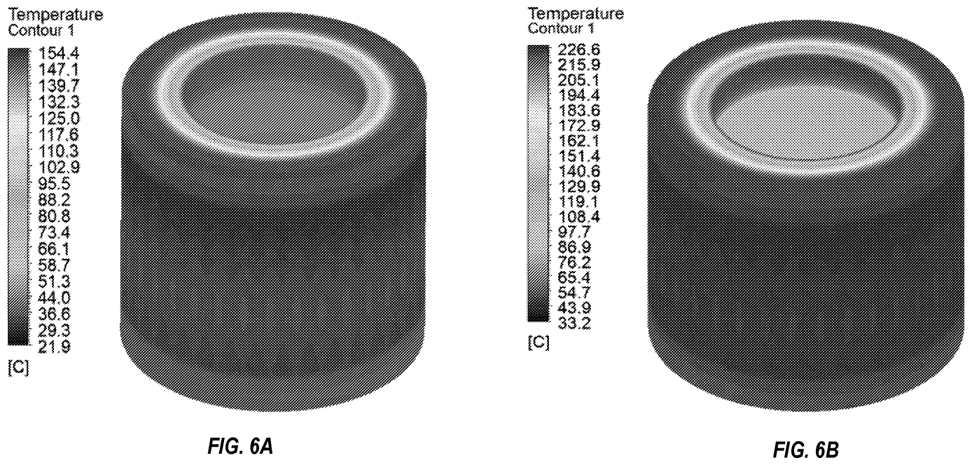

FIGS. 6A and 6B show a temperature comparison at the outer radius of the stator motor 230 (without cooling plates) when using aluminum (FIG. 6A) and using stainless steel (FIG. 6B) for the stator tube when the flywheel is operating at 37,500 revolutions per minute. This comparison is equivalent to the comparison shown in FIG. 5. In each of FIGS. 6A and 6B, the inner radius of the stator motor, where the cooling jacket is located, shows similar temperature as the other. The cooling jacket has an operating temperature of 18° C. and a cooling flow of 1 m/s though the cooling ducts. Lowering the operating temperature of the cooling jacket to below 5° C. did not significantly lower the outer-radius temperature when using stainless steel.

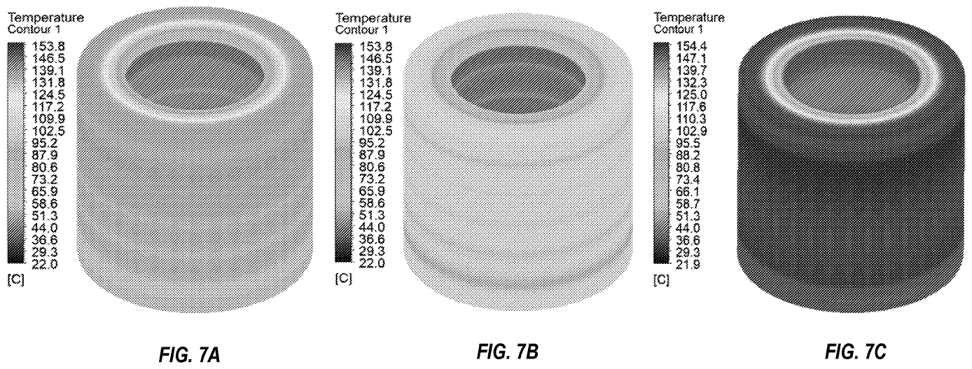

FIGS. 7A, 7B, and 7C show a comparison in temperature for the stator motors 110 and 134 when using aluminum for the stator tube 120 while the flywheel is operating at 37,500 revolutions per minute. FIG. 7A shows temperature gradient of the stator motor 110 with sapphire cooling plates. FIG. 7B shows temperature gradient of the stator motor 110 with ceramic AlN cooling plates. FIG. 7C shows the temperature gradient of the stator motor 134 without cooling plates.

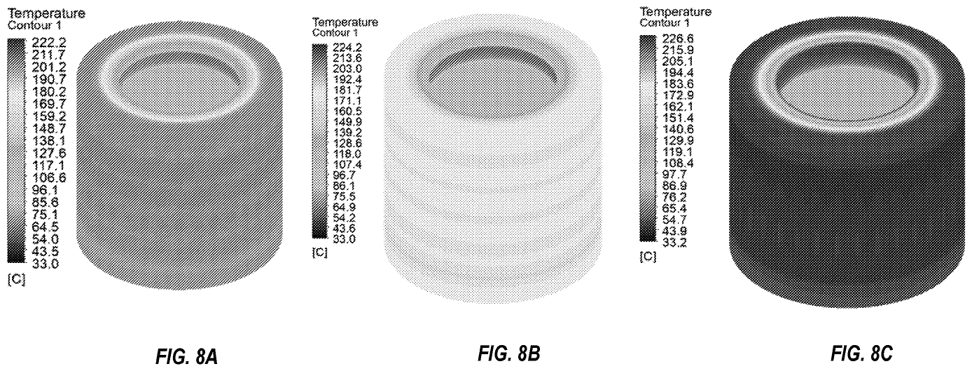

FIGS. 8A, 8B, and 8C show a comparison in temperature for the stator motors 110 and 134 when using stainless steel for the stator tube 120 while the flywheel is operating at 37,500 revolutions per minute. FIG. 8A shows temperature gradient of the stator motor 110 with sapphire cooling plates. FIG. 8B shows temperature gradient of the stator motor 110 with AlN ceramic cooling plates. FIG. 8C shows temperature gradient of the stator motor 134 without cooling plates.

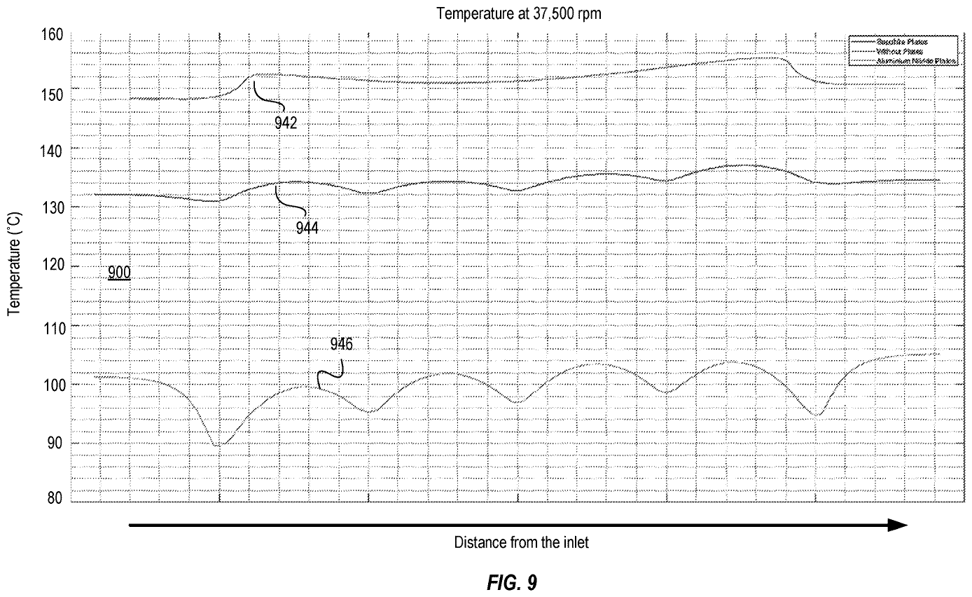

FIG. 9 is a temperature plot 900 of the outer radius of a stator motor showing the effect of having cooling plates. The temperature plot 900 is similar to the temperature plot 500, FIG. 5 and shows temperatures at the outer radius of the stator motor when the material used for the stator tube was aluminum. The temperature plot 900 includes a temperature trace 942 for a stator motor without a cooling plate (e.g., stator motor 134), a temperature trace 944 for a stator motor with sapphire cooling plates, and a temperature trace 946 for a stator motor with AlN ceramic cooling plates. The temperature range for the temperature trace 942 is 145° C. to 155° C. for the stator motor without a cooling plate, while the temperature range for the temperature trace 946 is 90° C. to 105° C. for the stator motor with AlN ceramic cooling plates.

Table 2 summarizes the average temperatures of the outer radius of the stator

TABLE 2

| | | Average |
|---|---|---|
| | | temperature of |
| | Stator design | stator motor |
| Stator tube material | (Cooling plate material) | (°C) |
| Aluminum | Stator motor 210 (sapphire) | 134.5 |
| | Stator motor 210 (AlN) | 100.0 |
| | Stator motor 230 | 152.4 |
| Stainless steel | Stator motor 210 (sapphire) | 202.8 |
| | Stator motor 210 (AlN) | 169.8 |
| | Stator motor 230 | 226.0 |

motor in various design and material selections presented herein.

### Flywheel System

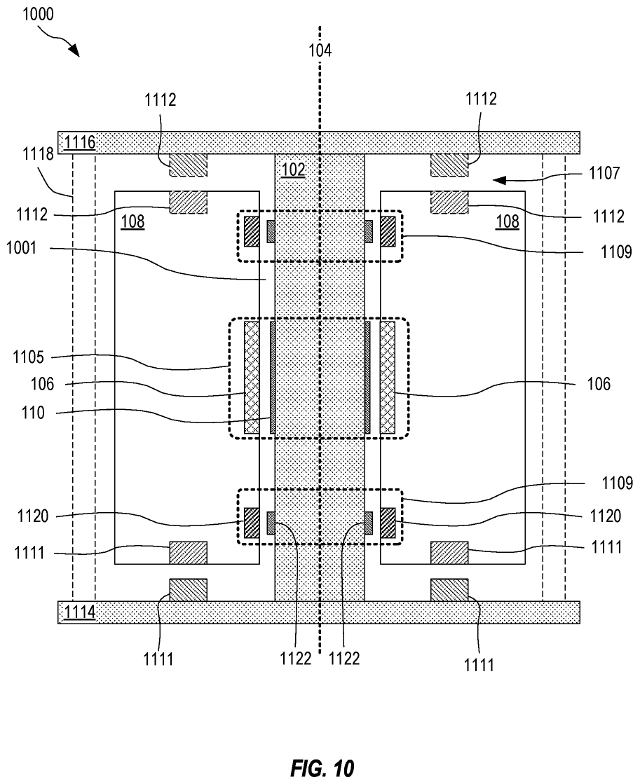

In embodiments, stator motor 110 or 134 may be used in a flywheel such as that shown in FIG. 10. FIG. 10 is for purposes of illustration, however, and principles of cooling a stator motor as discussed herein may be applied to any flywheel system using a stator motor mounted on a shaft inside a rotor.

FIG. 10 illustrates flywheel system 1000 having (a) a stationary shaft 102 and rotor 108. Stationary shaft 102 extends between bottom support 1114 and top support 1116. Radial wall 1118 may be included between bottom support 1114 and top support 1116 to provide vacuum chamber 1107.

Flywheel system 1000 includes at least one generator 1105 and typically the rotor is supported and stabilized by at least one magnetic bearing 1109. Other magnetic bearings, both active and passive, may be included along stationary shaft 102 without departing from the scope hereof. The stator motor 110 is disposed in an axial cavity 1001 of rotor 108 along axis 104. Permanent magnets 106 are attached to rotor 108 and act with stator motor 110 as a generator 1105 to speed rotation of rotor 108 when electrically driven, and slow rotation of rotor 108 while generating electric energy when coupled to do so. The rotor and stator motor may be enclosed in a vacuum chamber 1107. Rotor 108 is suspended, and stabilized axially, in vacuum chamber 1107 by magnetic bearings 1109 and suspension magnets 1111 on rotor 108 and bottom support 1114. In embodiments, additional suspension magnets 1112 may be provided between rotor 108 and top support 1116.

Each generator 1105 inductively converts rotational energy of rotor 108 to an electrical energy output of flywheel system 1000, and conversely, magnetically converts an electrical energy input to flywheel system 1000 to rotational energy of rotor 108 depending on a current operating mode. Generator 1105 may include (i) a plurality of permanent magnets 106 mechanically coupled with rotor 108, and (ii) a stator motor 110 mechanically coupled to stationary shaft 102. Generator stator 1105 magnetically couples with permanent magnets 106 to convert between rotational energy of rotor 108 and electric current in windings of stator motor 110.

Magnetic bearing(s) 1109 stabilizes the position of rotor 108 relative to stationary shaft 102. Each magnetic bearing 1109 may include (i) a plurality of magnetizable elements 1120 mechanically coupled with rotor 108, and (ii) a plurality of magnets 1122, that may in some embodiments be electromagnets, mechanically coupled to stationary shaft 102. Electromagnets 1122 magnetically couple with magnetizable elements 1120 to actively stabilize rotor 108 relative to stationary shaft 102.

When storing energy, the stator motor windings 118 (FIG. 2) are driven by a power source to speed rotation of rotor 108 and thereby store energy as kinetic energy, and when recovering kinetic energy the permanent magnets 106 induce electrical energy in stator motor windings 118 which can be tapped by energy recovery electronics to power other devices, as kinetic energy is recovered rotation of rotor 108 slows. Both the power source and energy recovery electronics are included in the flywheel system but not shown in FIG. 10.

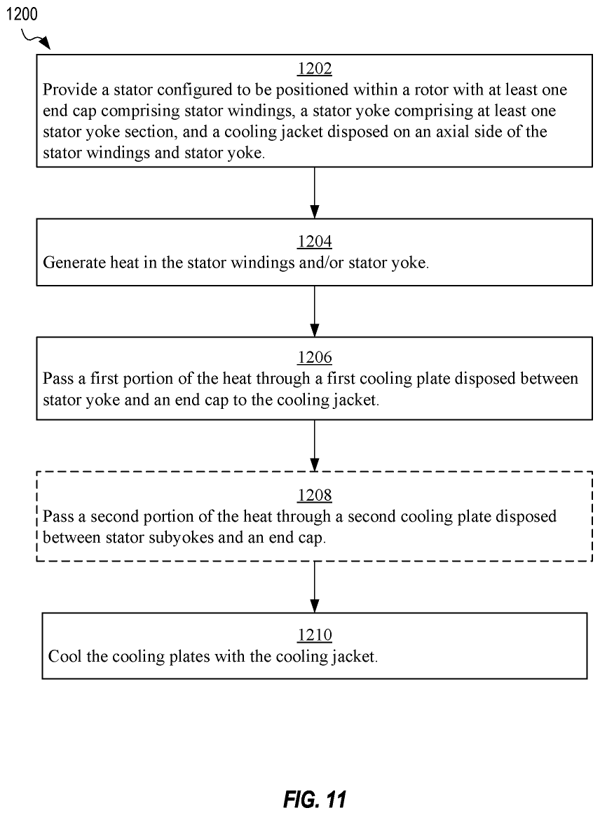

In operation of the flywheel system described above, FIG. 11 illustrates a method 1200 of cooling the flywheel motor includes providing a stator configured to be positioned within a rotor of the flywheel, the stator constructed with at least one end cap comprising stator windings, a stator yoke comprising at least one stator yoke sections, and a cooling jacket disposed on an axial side of the stator windings and stator yoke. Heat generated 1204 in the stator windings and/or stator yoke is divided into portions, a first portion of the heat passes 1206 into at least one first cooling plate disposed between the end cap and the stator yoke, and a second portion of the heat optionally passes through the into a second cooling plate. Heat is then passed 1210 from the cooling plates to the cooling jacket, which his cooled by flowing a liquid through the cooling jacket to remove heat from the stator.

### Combinations

The various features of stator motor and flywheel system herein described can be combined in many ways including some anticipated by the inventors including:

A stator motor designated A of a flywheel configured to be disposed within a cavity of, and along an axis of, a rotor of the flywheel and including: a stator tube; a cooling jacket disposed on a radially inward side of the stator tube; a stator yoke that extends from the radially inward side to a radially outward side of the stator motor; and at least one inductive winding.

A stator motor designated AA including the stator motor designated A, wherein the stator tube is positioned radially inward of the stator yoke of the stator motor and extending for an axial length of the stator motor.

A stator motor designated AB including the stator motor designated AA or A, further comprising a first potting end that caps a first axial end of the stator motor, and a second potting end that caps a second axial end of the stator motor, and where the at least one inductive winding is disposed within at least one of the potting ends.

A stator motor designated AC including the stator motor designated AB, AA, or A, the at least one inductive winding magnetically coupled to a rotor and configured to generate electrical current in response to the rotor rotating about the stator motor.

A stator motor designated AD including the stator motor designated AC, AB, AA, or A, the at least one inductive winding being further configured to rotate the rotor when supplied with electrical current.

A stator motor designated AD including the stator motor designated AC, AB, AA, or A the inductive winding comprising copper wire.

A stator motor designated AE including the stator motor designated AD, AC, AB, AA, or A, the cooling jacket comprising a plurality of cooling ducts.

A stator motor designated AF including the stator motor designated AE, AD, AC, AB, AA, or A the stator tube thermally coupled to a first cooling plate, the at least one cooling plate disposed between the first potting end and the stator yoke.

A stator motor designated AFA including the stator motor designated AF the first cooling plate comprising at least one of sapphire and aluminum nitride ceramic.

A stator motor designated AG including the stator motor designated AFA, AF, AE, AC, AB, AA, or A, the stator tube thermally coupled to at least one second cooling plate, the second cooling plate disposed between a first subyoke of the stator yoke and a second subyoke of the stator yoke.

A stator motor designated AGA including the stator motor designated AG, the second cooling plates comprising at least one of sapphire and aluminum nitride ceramic.

A stator motor designated AH including the stator motor designated AGA, AFA, AF, AG, AE, AD, AC, AB, AA, or A; where the stator tube is formed of one of stainless steel and aluminum.

A flywheel system designated B comprising a vacuum chamber enclosing the stator motor designated AH, AGA, AFA, AF, AG, AE, AD, AC, AB, AA, or A, a rotor disposed around the stator motor, and where the rotor is suspended in the vacuum chamber by magnetic bearings.

A flywheel system designated BA including the flywheel system designated B further comprising a power source coupled to the inductive winding of the stator motor and adapted to speed rotation of the rotor and energy recovery electronics coupled to the inductive winding of the stator motor and adapted to slow rotation of the rotor while recovering kinetic energy from the rotor.

A method designated C of recovering stored energy includes rotating the rotor the flywheel system designated BA or B wherein said rotating generates an electrical current in the inductive windings of the stator motor.

A method designated D of storing energy includes electrically driving the inductive windings of the stator motor of the flywheel system designated B or BA, wherein said electrically driving rotates the rotor around the stator motor.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A stator motor of a flywheel,
the stator motor configured to be disposed within a cavity of, and along an axis of, a rotor of the flywheel;
the stator motor comprising:
a stator tube;
a cooling jacket disposed on a radially inward side of the stator tube;
a stator yoke that extends from the radially inward side to a radially outward side of the stator motor; and
at least one inductive winding.

2. The stator motor of claim 1, wherein the stator tube is positioned radially inward of the stator yoke of the stator motor and extending for an axial length of the stator motor.

3. The stator motor of claim 2, further comprising a first potting end that caps a first axial end of the stator motor, and a second potting end that caps a second axial end of the stator motor, and where the at least one inductive winding disposed within at least one of the potting ends.

4. The stator motor of any one of claim 3, the at least one inductive winding magnetically coupled to a rotor and configured to generate electrical current in response to the rotor rotating about the stator motor.

5. The stator motor of claim 4, the at least one inductive winding being further configured to rotate the rotor when supplied with electrical current.

6. The stator motor of claim 5, the inductive winding comprising copper wire.

7. The stator motor of any one of claims 3 to 6, the cooling jacket comprising a plurality of cooling ducts.

8. The stator motor of claim 7 the stator tube thermally coupled to a first cooling plate, the first cooling plate disposed between the first potting end and the stator yoke.

9. The stator motor of claim 8, the stator tube thermally coupled to at least one second cooling plate, the second cooling plate disposed between a first subyoke of the stator yoke and a second subyoke of the stator yoke.

10. The stator motor of claim 9, the first cooling plate comprising at least one of sapphire and aluminum nitride ceramic.

11. The stator motor of any one of claim 7, the stator tube comprising one of stainless steel and aluminum.

12. A flywheel energy storage system comprising a vacuum chamber enclosing the stator motor of claim 10, and a rotor disposed around the stator motor, the rotor suspended in the vacuum chamber by magnetic bearings.

13. The flywheel system of claim 12 further comprising a power source coupled to the inductive winding of the stator motor and adapted to speed rotation of the rotor, and energy recovery electronics coupled to the inductive winding of the stator motor and adapted to slow rotation of the rotor while recovering kinetic energy from the rotor.

14. A method of recovering stored energy comprising rotating the rotor of the flywheel system of claim 13 wherein said rotating generates an electrical current in the inductive windings of the stator motor.

15. A method storing energy comprising electrically driving the inductive windings of the stator motor of the flywheel system of claim 14, wherein said electrically driving rotates the rotor around the stator motor.

16. A method of cooling a stator for a motor, comprising:
providing a stator configured to be positioned within a rotor, the stator comprising:
at least one end cap comprising stator windings,
a stator yoke comprising at least one stator yoke sections, and
a cooling jacket disposed on an axial side of the stator windings and the stator yoke;
generating heat in the stator windings and/or the stator yoke
passing at least a first portion of the heat into at least one first cooling plate disposed between the end cap and the stator yoke to the cooling jacket; and
cooling the cooling jacket by flowing a liquid through the cooling jacket to remove the heat from the stator.

17. The method of claim 16 further comprising providing a second cooling plate between a first stator yoke section of the at least one stator yoke sections and a second stator yoke section of the at least one stator yoke sections;
passing a second portion of the heat into the second cooling plate, and
passing the second portion of the heat through the second cooling plate into the cooling jacket.

18. The method of claim 17 where the first and second cooling plate are formed of sapphire or aluminum nitride ceramic.
